(19) United States
(12) Patent Application Publication
(10) Pub. No.: US 2020/0160089 A1
(43) Pub. Date: May 21, 2020

(54) VISUAL PATTERN RECOGNITION WITH SELECTIVE ILLUMINATION FOR ASSISTED INSPECTION

(71) Applicant: INTERNATIONAL BUSINESS MACHINES CORPORATION, Armonk, NY (US)

(72) Inventor: Carlos Eduardo Jimenez Pelayo, Zapopan (MX)

(21) Appl. No.: 16/191,822

(22) Filed: Nov. 15, 2018

(51) Int. Cl. G06K 9/46; G06K 9/62; G06K 9/20

(52) U.S. Cl. CPC G06K 9/4671; G06K 2009/6213; G06K 9/2054; G06K 9/627

(57) ABSTRACT

A method, computer system, and a computer program product for visual pattern recognition is provided. The present invention may include capturing one or more images of a reference object and an object under inspection. The present invention may then include processing the one or more images of the reference object and the object under inspection. The present invention may lastly include determining that the reference object and the object under inspection are not a match.

### BACKGROUND

The present invention relates generally to the field of computing, and more particularly to capturing and processing digital images.

Automated optical inspection systems provide an automated visual inspection of circuit boards or standalone electronic cards, among other objects, by utilizing a camera to capture images of the object (e.g., the circuit board or standalone electronic card) which may reveal a defect and/or a failure of the object.

### SUMMARY

Embodiments of the present invention disclose a method, computer system, and a computer program product for visual pattern recognition. The present invention may include capturing one or more images of a reference object and an object under inspection. The present invention may then include processing the one or more images of the reference object and the object under inspection. The present invention may lastly include determining that the reference object and the object under inspection are not a match.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for visual pattern recognition according to at least one embodiment;

FIG. 3 is a block diagram of the components of the visual pattern recognition program according to at least one embodiment;

FIG. 4A is an exemplary illustration of the top view of the components of the visual pattern recognition program according to at least one embodiment;

FIG. 4B is an exemplary illustration of the side view of the components of the visual pattern recognition program according to at least one embodiment;

FIG. 5 is an exemplary illustration of an object viewed using light from a single source according to at least one embodiment;

FIG. 6 is an exemplary illustration of an object viewed using light from two sources according to at least one embodiment;

FIG. 7 is an exemplary illustration of an object comparison according to at least one embodiment;

FIG. 8 is an exemplary illustration of an inspection area with additional lamps according to at least one embodiment;

FIG. 9 is an exemplary illustration of an inspection area with an additional camera according to at least one embodiment;

FIG. 10 is an exemplary illustration of an inspection area with an additional mirror according to at least one embodiment;

FIG. 11 is a block diagram of internal and external components of computers and servers depicted in FIG. 1 according to at least one embodiment;

FIG. 12 is a block diagram of an illustrative cloud computing environment including the computer system depicted in FIG. 1, in accordance with an embodiment of the present disclosure; and

FIG. 13 is a block diagram of functional layers of the illustrative cloud computing environment of FIG. 12, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for visual pattern recognition. As such, the present embodiment has the capacity to improve the technical field of capturing and processing digital images by comparing objects under inspection to one or more reference objects. More specifically, the present invention may include capturing one or more images of a reference object and an object under inspection. The present invention may then include processing the one or more images of the reference object and the object under inspection. The present invention may lastly include determining that the reference object and the object under inspection are not a match.

Embodiments of the present invention recognize that automated optical inspection systems provide an automated visual inspection of circuit boards or standalone electronic cards by utilizing a camera to capture images of the object (e.g., the circuit board or standalone electronic card) which may reveal a defect and/or a failure of the object, among other things.

Embodiments of the present invention further recognize that existing solutions may have a costly implementation and configuration process and may not enable a scanning speed and a lighting setup which facilitate automatic photographs to be taken from one more angles with one or more light sources. Therefore, it may be advantageous to, among other things, provide a solution which enables automatic photographs to be taken from one or more angles under one or more light sources, and which improves the inspection of objects by teaching the visual pattern recognition program to turn on and off connected light sources, and to recognize the differences of an object under inspection from one or more reference objects.

Embodiments of the present invention may capture a sequence of photographs of a reference object and may extract characteristics of the reference object (e.g., shadows, colors, and/or contours). The reference object may then be replaced by an object under inspection, and the system may capture a similar sequence of photographs. A comparison may be done between the photographs of the reference object and the photographs of the object under inspection. Results of the comparison may be displayed on two images positioned side by side, where one image may depict the reference object fully illuminated, and the second image may depict the object under inspection fully illuminated. The results may highlight areas of difference between the reference object and the object under inspection, and a threshold may be used to distinguish the importance of each highlighted area. For example, an area with a high number of varying pixels may be highlighted with a brighter color and/or intensity, and an area with fewer varying pixels may be highlighted with a darker color and/or intensity.

Embodiments of the present invention may follow a predetermined capturing and lighting sequence. For example, when a reference object or an object under inspection is in position, and the system is requested to capture photographs, the following sequence may be followed: all lights off, light 1 on, camera capture and save, light 1 off, light 2 on, camera capture and save, light 2 off, light 3 on, camera capture and save, light 3 off, light 4 on, camera capture and save, all lights on, camera capture and save, all lights off, camera capture and save. This last step may capture the lighting from the background fill light, which may be turned on at all times.

Embodiments of the present invention may determine that areas that have a small number of varying pixels (e.g., where the pixel variation falls below a predefined threshold) between the reference object and the object under inspection may be similar. However, an electronic component may be installed on an electronic card at an offset from the install location. In this instance, machine learning algorithms may be used to identify the electronic component and to discard any “false positive” findings. The differences between the reference object and the object under inspection may be determined to be expected, may be explained, and/or may be determined to be nominal (e.g., may be a good match).

Embodiments of the present invention may include a machine for assisted optical inspection with a flat surface upon which the object under inspection may be placed, one or more cameras installed perpendicularly above this surface, a set of light-emitting diode (LED) light bars arranged to illuminate the surface at an angle, and a control processing unit (CPU) where the camera and the lights are attached.

Embodiments of the present invention may include a method for capturing a group of images using different lighting scenarios for an object, such as an electronic card, where the images depict shadows, contours, and/or colored areas, and where the shadows cast by the group of images along with the contours and/or the colored areas create a visual pattern for the object. A visual pattern may be a combination of black and white areas depicting the shape of the object as it appears based on the casted shadows, complemented by the object's contours and/or the object's colored areas. The method may store the created visual pattern as a reference pattern within a database located on a computing device. Thereafter, when an object similar to the reference object is inspected, a group of images may be captured, processed, and stored, and a newly created visual pattern may be compared against the visual pattern of the reference object, in order to highlight and identify any differences which may be indicative of a failure and/or a defect of the object.

Embodiments of the present invention may generate one or more comparison points, which may appear in the visual pattern, based on the quantity of images taken of a particular object. Photographs of additional comparison points may be obtained through the utilization of additional LED light bars and cameras, by directing the focus of an additional camera to a different point on the object.

Embodiments of the present invention may capture several images using different shadow casting scenarios in order to provide additional comparison points for use in highlighting potential differences between the object and a reference object.

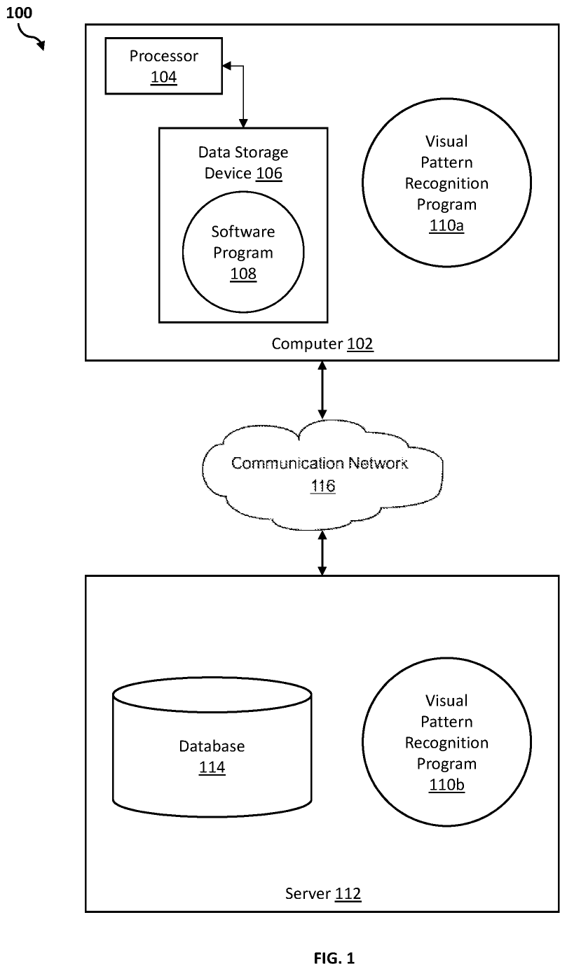

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a visual pattern recognition program 110a. The networked computer environment 100 may also include a server 112 that is enabled to run a visual pattern recognition program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

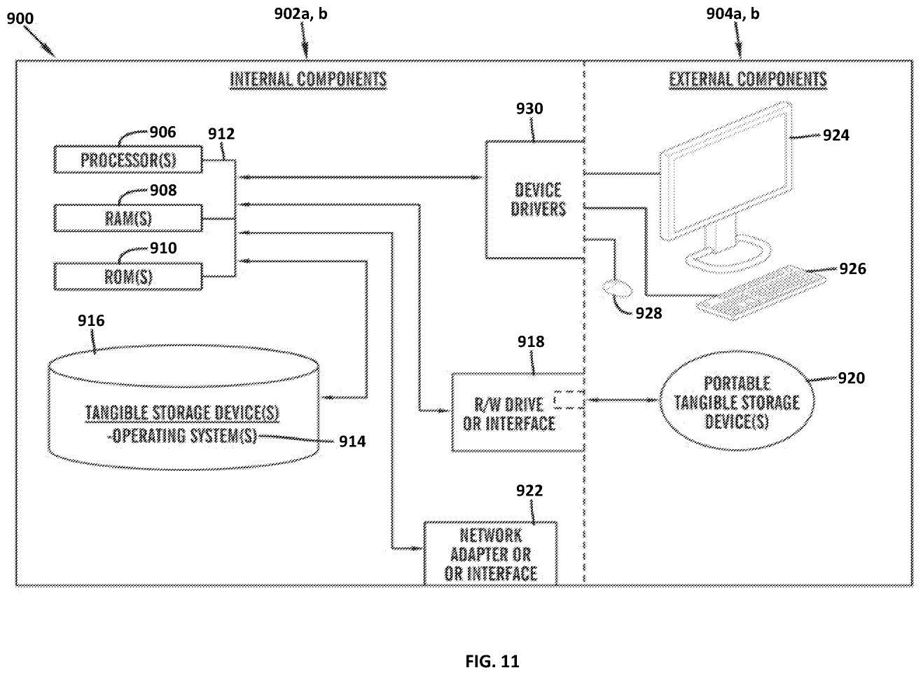

The client computer 102 may communicate with the server computer 112 via the communications network 116. The communications network 116 may include connections, such as wire, wireless communication links, or fiber optic cables. As will be discussed with reference to FIG. 11, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the visual pattern recognition program 110a, 110b may interact with a database 114 that may be embedded in various storage devices, such as, but not limited to a computer/mobile device 102, a networked server 112, or a cloud storage service.

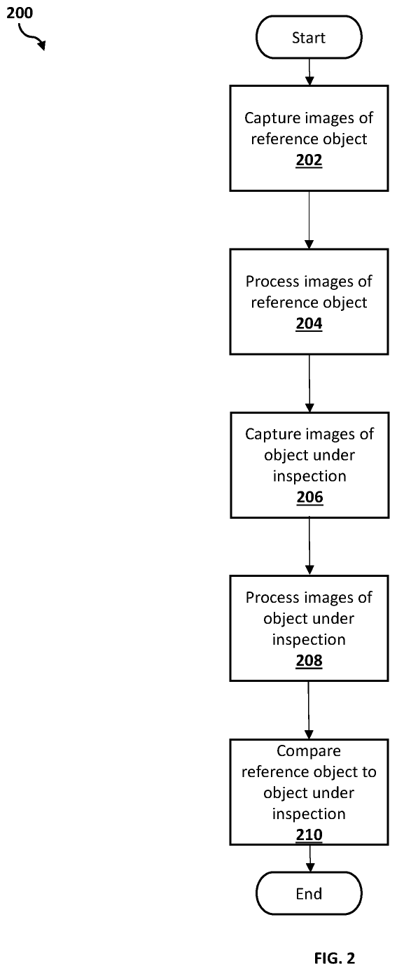

According to the present embodiment, a user using a client computer 102 or a server computer 112 may use the visual pattern recognition program 110a, 110b (respectively) to improve the inspection of objects under specified lighting conditions, by comparing an object under inspection to a reference object. The visual pattern recognition method is explained in more detail below with respect to FIGS. 2-10.

Referring now to FIG. 2, an operational flowchart illustrating the exemplary visual pattern recognition process 200 used by the visual pattern recognition program 110a and 110b according to at least one embodiment is depicted.

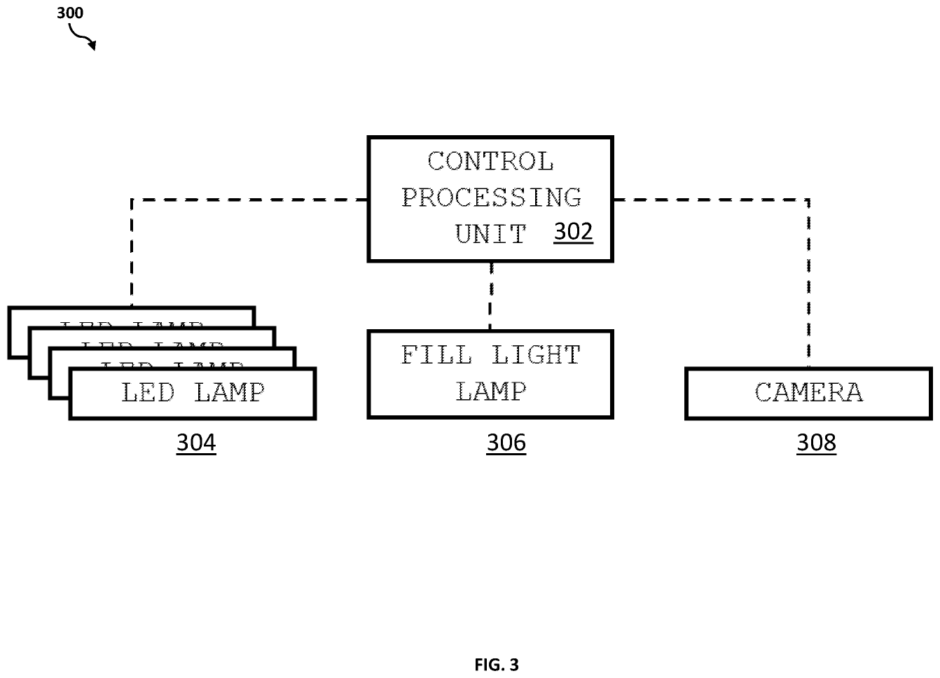

At 202, the visual pattern recognition program 110a, 110b captures images of a reference object. The visual pattern recognition program 110a, 110b may utilize an automated optical inspection machine with a flat surface upon which the object under inspection may be positioned, as well as a camera installed perpendicularly above the flat surface. The camera lens may be directed to the center of the flat surface, where the object under inspection may be placed. The camera may further be connected to a control processing unit (CPU) which may command the operation of the connected camera. Light-emitting diode (LED) reflector light bars may be arranged at an angle which points downward towards the center of the inspection surface. The components of the visual pattern recognition program 110a, 110b will be discussed in more detail with respect to FIG. 3 below.

The CPU may direct the capture of images of a reference object by first documenting the reference object with identifiers (e.g., by creating a data structure with the identification information which will contain the captured images of the identified object), such as a part number, a serial number, and/or a revision number, among other means of identification. In instances where an identifying label may be clear and visible on an automated photograph, identifying information for each card may be captured by the visual pattern recognition program 110a, 110b using optical character recognition (OCR) techniques. In instances where an identifying label may not be clear and/or visible on an automated photograph, the visual pattern recognition program 110a, 110b may request the operator to scan or type the card information. Identifying information may be stored as embedded metadata within the captured photographs, or may be saved in a database (e.g., database 114)).

The CPU may locate the reference object within an inspection area of the automated optical inspection machine (e.g., using the lens of the camera). The object may be placed within the inspection area in a predefined manner, such as with the top of a standalone electronic card always facing in the same direction. The entirety of the object or just a section of it may be viewed through the lens of the connected camera.

The fill lamp may then be turned on and the CPU may capture a group of images (the CPU may control both the camera and the lighting system), synchronizing the shooting of the image with each LED reflector light bar that is turned on, thereby resulting in selective illumination. For example, an image is taken each time a connected LED reflector light bar is turned on. The connected LED reflector light bars do not remain turned on after the image is captured. However, once images are captured with each connected LED reflector light bar being individually turned on, then the CPU of the visual pattern recognition program 110a, 110b may turn on two or more connected LED reflector light bars and may capture additional images.

Each captured image may be stored in the CPU of the visual pattern recognition program 110a, 110b and may be linked with the corresponding identifier, as described previously.

At 204, the visual pattern recognition program 110a, 110b processes images of a reference object.

The visual pattern recognition program 110a, 110b may capture several images using differing shadow casting scenarios, as described previously with respect to step 202 above, which may provide for additional comparison points to highlight any potential differences of a reference object and an object under inspection. While a single image may include reflections from shining surfaces, among other outside noise, a comparison of images (e.g., a comparison of images taken using different shadow casting scenarios) may more clearly differentiate the shining surface from the observed object and may improve the visual pattern recognition program's 110a, 110b understanding of the observed object.

As described previously, the visual pattern recognition program 110a, 110b may include machine learning techniques. A user of the program may add labels (e.g., tags or identification tags) for specific cases and/or situations, and the visual pattern recognition program 110a, 110b may apply a predefined treatment for such identified cases, which may improve the outcome of newly inspected objects. For example, by utilizing a machine learning technique, the visual pattern recognition program 110a, 110b may learn to identify a shiny reflective area within the camera's view and know that the shiny reflective area should not be considered part of the captured image.

In order to create a pattern from the captured images, the visual pattern recognition program 110a, 110b may store each photograph as a separate file on a connected database (e.g., database 114) and may additionally and/or optionally combine the photographs into a single image file containing multiple layers. Combining all photographs into a single image file may emphasize the various shadows observed by the visual pattern recognition program 110a, 110b.

The CPU of the visual pattern recognition program 110a, 110b may perform visual recognition of the shadows casted using all captured images. The group of shadows may be processed and stored as a visual pattern for the reference object. Shadows may be detected through the use of different methods, including methods which may operate based on color, physical characteristics, geometries, and/or textures.

This process may be performed for each reference object of which images are captured.

At 206, the visual pattern recognition program 110a, 110b captures images of an object under inspection.

The visual pattern recognition program 110a, 110b may determine that an object under inspection is similar to a reference object by first locating the object within the inspection area of the automated optical inspection machine, as described previously with respect to step 202 above. The visual pattern recognition program 110a, 110b may then confirm that the identifiers of the object under inspection are the same as the identifiers of the reference object (e.g., that the part numbers, serial numbers, and/or revision numbers match). The visual pattern recognition program may alternatively identify the object under inspection as unique by documenting the identifiers of the object under inspection (e.g., by creating a data structure with the identification information which will contain the captured images of the object under inspection). Identifiers of the object under inspection may include, but are not limited to including, a serial number and/or a name.

The CPU of the visual pattern recognition program 110a, 110b may capture images of the object under inspection based on the same sequence that was used to capture images of the reference object, as described previously with respect to step 202 above.

At 208, the visual pattern recognition program 110a, 110b processes images of the object under inspection. As was described previously with respect to step 204 above, the CPU of the visual pattern recognition program 110a, 110b may perform visual recognition (e.g., processing) of the shadows in the captured images of the object under inspection. The processed shadows may then be stored as a visual pattern for the object under inspection and may be compared against the visual pattern for the reference object that was created by the visual pattern recognition program 110a, 110b.

At 210, the visual pattern recognition program 110a, 110b compares the reference object to the object under inspection. Once a visual pattern has been created for both the reference object and an object under inspection, as described previously with respect to steps 204 and 208 above, then the visual patterns are compared. A comparison of the visual patterns may reveal similarities and/or differences of the reference object and the object under inspection. As described previously, a small amount (e.g., one falling below a predefined threshold) of varying pixels between the reference object and the object under inspection may reveal that the two objects are considered similar.

A comparison of images may be achieved when the visual pattern recognition program 110a, 110b captures photographs of the reference object and the object under inspection at the same location on the automated optical inspection machine. If the reference object and the object under inspection were photographed while resting at different locations on the automated optical inspection machine, then the visual pattern recognition program 110a, 110b may utilize image registering algorithms to align the images and perform a comparison.

If the visual pattern recognition program 110a, 110b finds a mismatch (e.g., determines that the reference object and the object under inspection are not similar) in the compared visual patterns, then the differences of the reference object and the object under inspection may be identified. If the visual pattern recognition program 110a, 110b determines that the reference object and the object under inspection are not similar, then the CPU of the visual pattern recognition program 110a, 110b may denote (e.g., may highlight, illuminate, change the color of, place a box around) the differences and may identify the object under inspection as a mismatch to the reference object. As was described previously with respect to steps 202 and 206 above, an identification may be noted within a created data structure for the object under inspection.

Mismatches in compared visual patterns may include, but are not limited to including, missing components of the inspected object, damaged components of the inspected object, and/or variations in the inspected object.

If the visual pattern recognition program 110a, 110b does not find a mismatch in the compared visual patterns (e.g., between the reference object and the object under inspection) then the object under inspection may be determined to be a match.

The visual pattern recognition program 110a, 110b may be configured to compare a visual pattern of an object under inspection to a visual pattern of only one reference object, or to a visual pattern of one or more combinations of reference objects.

Referring now to FIG. 3, a block diagram 300 of the components of the visual pattern recognition program 110a, 110b according to at least one embodiment is depicted. The visual pattern recognition program 110a, 110b may include a control processing unit 302, an LED lamp 304, a fill light lamp 306, and a camera 308, among other components. As described previously with respect to step 202 above, the visual pattern recognition program 110a, 110b may utilize an automated optical inspection machine with a flat surface where the object under inspection may be positioned, as well as a camera installed perpendicularly above the flat surface. The camera lens may be directed to the center of the flat surface, where the object under inspection may be placed. The camera may further be connected to a control processing unit (CPU) which may command the operation of the connected camera. Light-emitting diode (LED) reflector light bars may be arranged at an angle which points downward towards the center of the inspection surface.

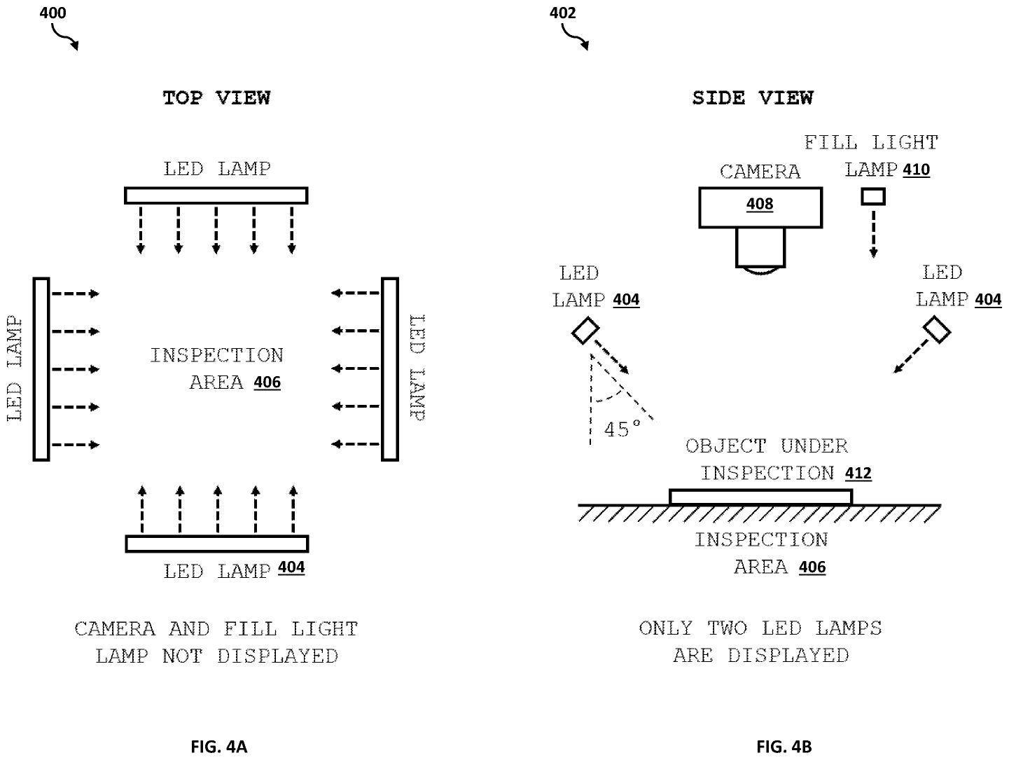

Referring now to FIG. 4A, an exemplary illustration of the top view of the components of the visual pattern recognition program 110a, 110b 400 according to at least one embodiment is depicted.

As described previously with respect to FIG. 3 above, four LED reflector light bars 404 may be arranged horizontally, positioned at 90-degree intervals from the camera, and pointing downward at a 45-degree angle (i.e., the angle of incidence) towards the center of the inspection surface (i.e., inspection area 406). If the angle of incidence of the LED reflector light bars is modified, then a reference object and an object under inspection may still be required to use the same setup so as to maintain original lighting conditions.

The four LED reflector light bars depicted here may have enough lighting power to cast a well-defined shadow of the object under inspection, which may be captured by a connected camera of the visual pattern recognition program 110a, 110b. The four LED reflector light bars may be further connected to the CPU which may command their operation.

A fill light lamp with lower wattage may also be positioned above the inspection surface, giving a small amount of scatter light to avoid any area from becoming too dark.

Referring now to FIG. 4B, an exemplary illustration of the side view of the components of the visual pattern recognition program 110a, 110b 402 according to at least one embodiment is depicted. The side view of the components of the visual pattern recognition program 110a, 110b 402 depict an LED lamp 404, an inspection area 406, a camera 408, a fill light lamp 410, and an object under inspection 412.

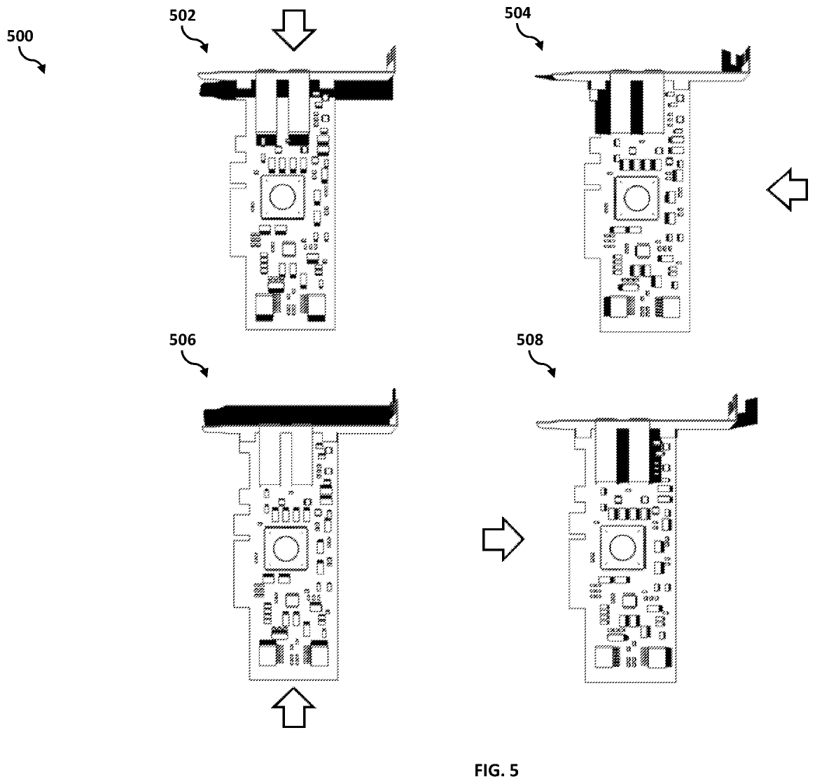

Referring now to FIG. 5, an exemplary illustration of an object viewed using light from a single source 500 according to at least one embodiment is depicted. As described previously with respect to step 202 above, light from a single source may be generated and an image may be captured with the turning on of each connected light source (i.e., LED reflector light bar). Each image may be stored in the CPU of the visual pattern recognition program 110a, 110b and may be linked to the corresponding identifiers.

The captured images 502, 504, 506, and 508 may depict the object viewed using light from a single source. In 502, the image of the object may be captured using a front light source; in 504, the image of the object may be captured using light from a right-side light source; in 506, the image of the object may be captured using light from a back light source; and in 508, the image of the object may be captured using light from a left-side light source.

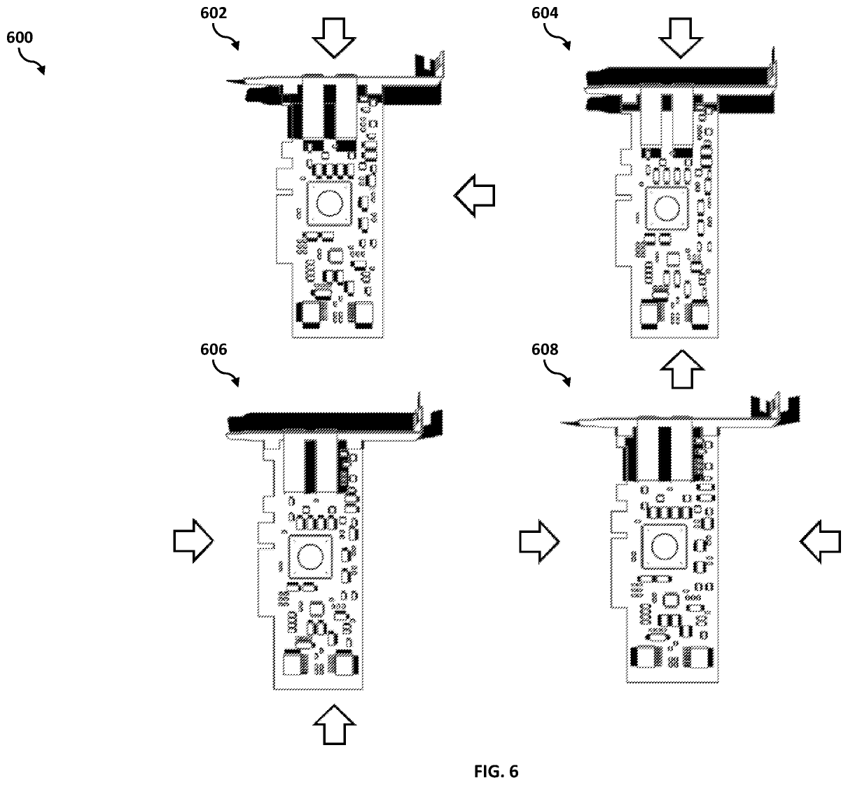

Referring now to FIG. 6, an exemplary illustration of an object viewed using light from two sources 600 according to at least one embodiment is depicted. As described previously with respect to step 202 above, the CPU of the visual pattern recognition program 110a, 110b may direct the capture of images using combinations of two or more light sources. The arrows in the image indicate the direction from which the light is being emitted. The light intensity may be moderated by the CPU of the visual pattern recognition program 110a, 110b to improve the shadow casted.

The captured images 602, 604, 606, and 608 may depict the object viewed using light from two sources. In 602, the image of the object may be captured using a front light source and a right-side light source; in 604, the image of the object may be captured using light from a front light source and a back light source; in 606, the image of the object may be captured using light from a back light source and a left-side light source; and in 608, the image of the object may be captured using light from a left-side light source and a right-side light source.

Where the light intensity is moderated by the CPU of the visual pattern recognition program 110a, 110b to have a lesser impact, the resulting image may be darker than images which were captured using a greater light intensity.

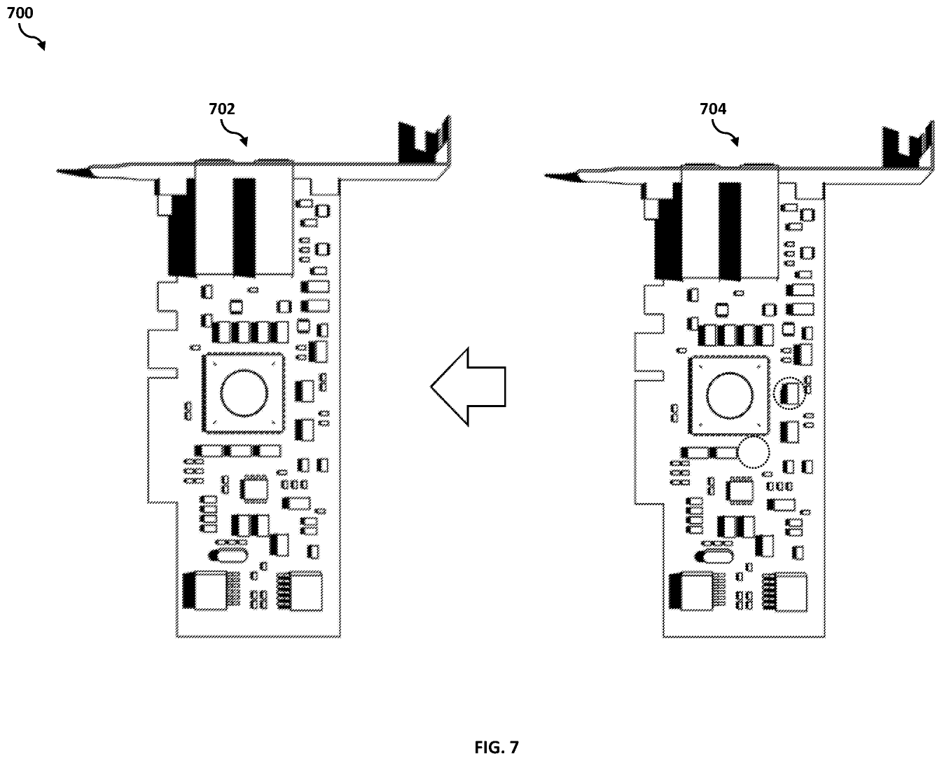

Referring now to FIG. 7, an exemplary illustration of an object comparison 700 according to at least one embodiment is depicted. Once a visual pattern has been created for both the reference object and an object under inspection, as described previously with respect to steps 204 and 208 above, the visual patterns are compared. A comparison of the visual patterns may reveal similarities and/or differences of the reference object and the object under inspection.

As was described previously with respect to step 210 above, if the visual pattern recognition program 110a, 110b does not find a mismatch in the compared visual patterns (e.g., between the reference object and the object under inspection) then the object under inspection may be determined to be a match.

As can be seen here in the highlighted (e.g., circled) components of the resulting image of the object under inspection 704, this object comparison revealed that the object under inspection 704 and the reference object 702 were not a match, as components of the object under inspection 702 were seen on one visual pattern were not seen on the visual pattern for the reference object 702.

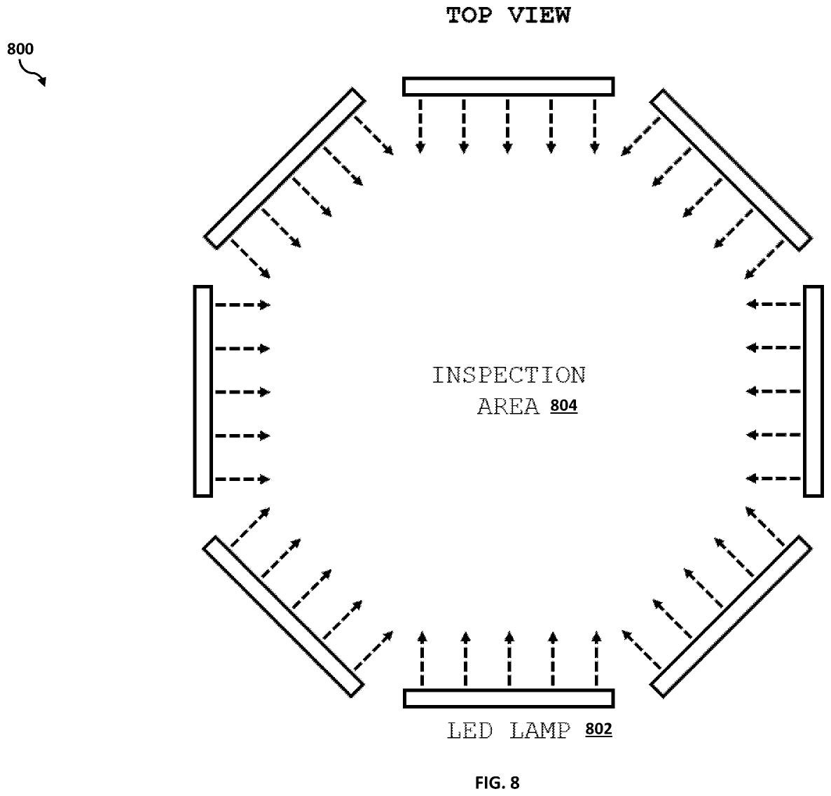

Referring now to FIG. 8, an exemplary illustration of a top view 800 of an inspection area with additional lamps according to at least one embodiment is depicted. As was described previously, components of the visual pattern recognition program 110a, 110b may differ. Additional lamps, such as eight LED lamp 802 reflector light bars, as depicted here, may generate an extended combination of lighting conditions from different angles, and may provide for further comparison points. The eight LED lamp 802 reflector light bars shine onto inspection area 804, as depicted here.

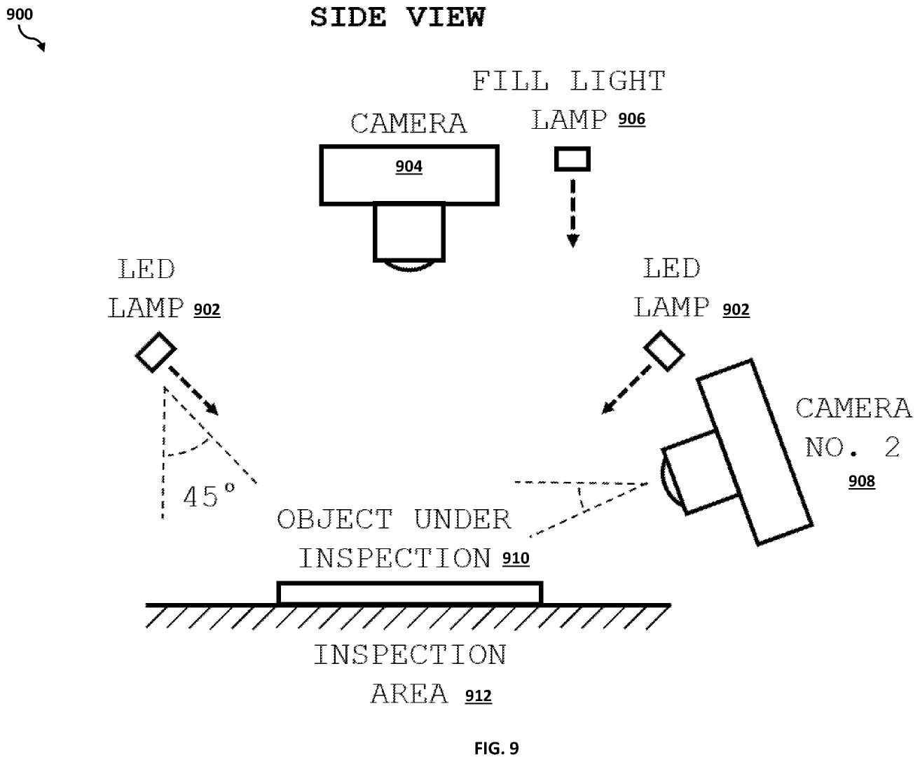

Referring now to FIG. 9, an exemplary illustration of a side view 900 of an inspection area with an additional camera according to at least one embodiment is depicted. As was described previously, components of the visual pattern recognition program 110a, 110b may differ. The visual pattern recognition program 110a, 110b may be adapted, as here, to include one or more cameras (e.g., camera 904), if it is determined that the object under inspection 910 includes an area of interest which cannot be seen by the camera 904 within the inspection area 912, using light from the LED lamp 902 and fill light lamp 906. An additional camera 908, as depicted here, may permit the visual pattern recognition program 110a, 110b to capture an image of the object under inspection 910 at an angle that was not previously seen with a single camera (e.g., camera 904).

The visual pattern recognition program 110a, 110b may determine that not all angles are being seen by measuring the length of the cast shadows and comparing the length of the cast shadows to a threshold distance. For example, several electronic cards may have external ports (e.g., ethernet, universal serial bus (USB), gigabit interface converter (GBIC), among others) which may be taller than the rest of the components, and the inside of their receptacles may not be visible from a camera located on the top. Likewise, the electronic card may have components that are shorter than the majority. In such cases, a user of the visual pattern recognition program 110a, 110b may configure a second camera facing the location of the ports (e.g., from the side of the electronic card), in order to see the receptacles with sufficient detail. Another option may be to install one or more lateral mirrors which may capture additional details of the electronic card using the same camera, as described previously with respect to FIG. 8 above.

Images captured with additional cameras may be done simultaneously to images captured with the original cameras or may be done with a separate and distinct lighting sequence.

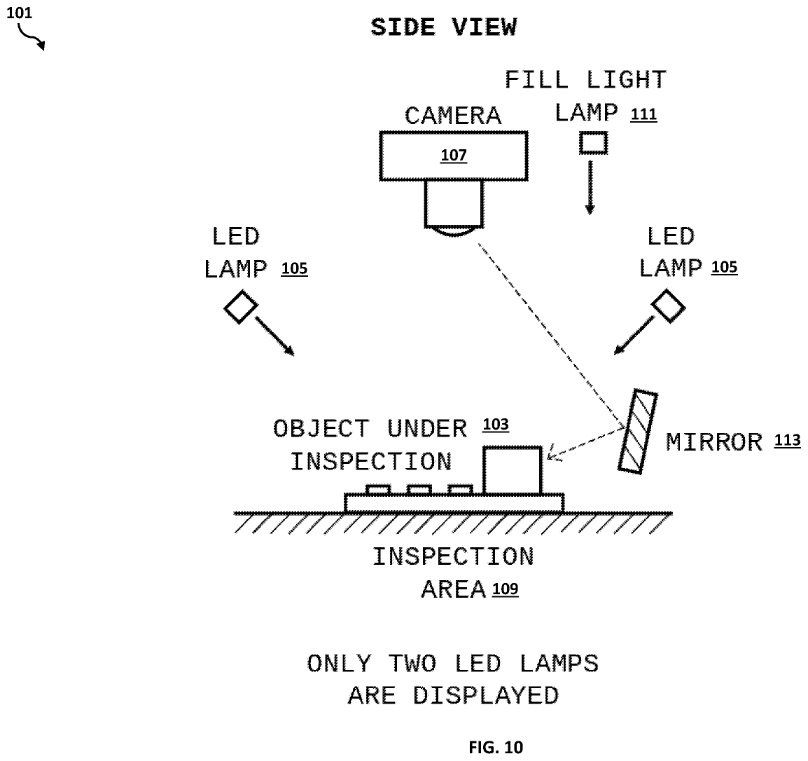

Referring now to FIG. 10, an exemplary illustration of an inspection area with an additional mirror 101 according to at least one embodiment is depicted. As described previously, the visual pattern recognition program 110a, 110b may be adapted to obtain photographs which may capture as many angles of the object under inspection 103 as possible. FIG. 10 depicts a scenario whereby two LED lamps 105 provide light for the object under inspection 103 to be seen by the camera 107 within the inspection area 109. A fill lamp 111 may provide additional light on the object under inspection 103. The key to this setup may be the that or more lateral mirrors (e.g., mirror 113) may be installed to the side of the object under inspection to capture additional details of the electronic card which may not be otherwise visible.

It may be appreciated that FIGS. 2-10 provide only an illustration of one embodiment and do not imply any limitations with regard to how different embodiments may be implemented. Many modifications to the depicted embodiment(s) may be made based on design and implementation requirements.

FIG. 11 is a block diagram 900 of internal and external components of computers depicted in FIG. 1 in accordance with an illustrative embodiment of the present invention. It should be appreciated that FIG. 11 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 11. Each of the sets of internal components 902 a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the visual pattern recognition program 110a in client computer 102, and the visual pattern recognition program 110b in network server 112, may be stored on one or more computer-readable tangible storage devices 916 for execution by one or more processors 906 via one or more RAMs 908 (which typically include cache memory). In the embodiment illustrated in FIG. 11, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the visual pattern recognition program 110a and 110b can be stored on one or more of the respective portable computer-readable tangible storage devices 920, read via the respective R/W drive or interface 918 and loaded into the respective hard drive 916.

Each set of internal components 902 a, b may also include network adapters (or switch port cards) or interfaces 922 such as a TCP/IP adapter cards, wireless wi-fi interface cards, or 3G or 4G wireless interface cards or other wired or wireless communication links. The software program 108 and the visual pattern recognition program 110a in client computer 102 and the visual pattern recognition program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the visual pattern recognition program 110a in client computer 102 and the visual pattern recognition program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

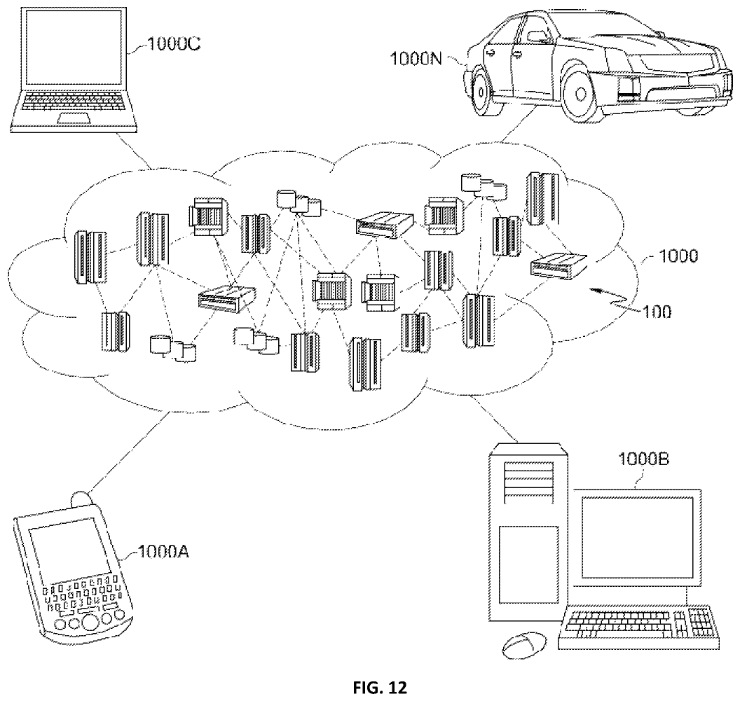

Referring now to FIG. 12, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 12 are intended to be illustrative only and that computing nodes 100 and cloud computing environment 1000 can communicate with any type of computerized device over any type of network and/or network addressable connection (e.g., using a web browser).

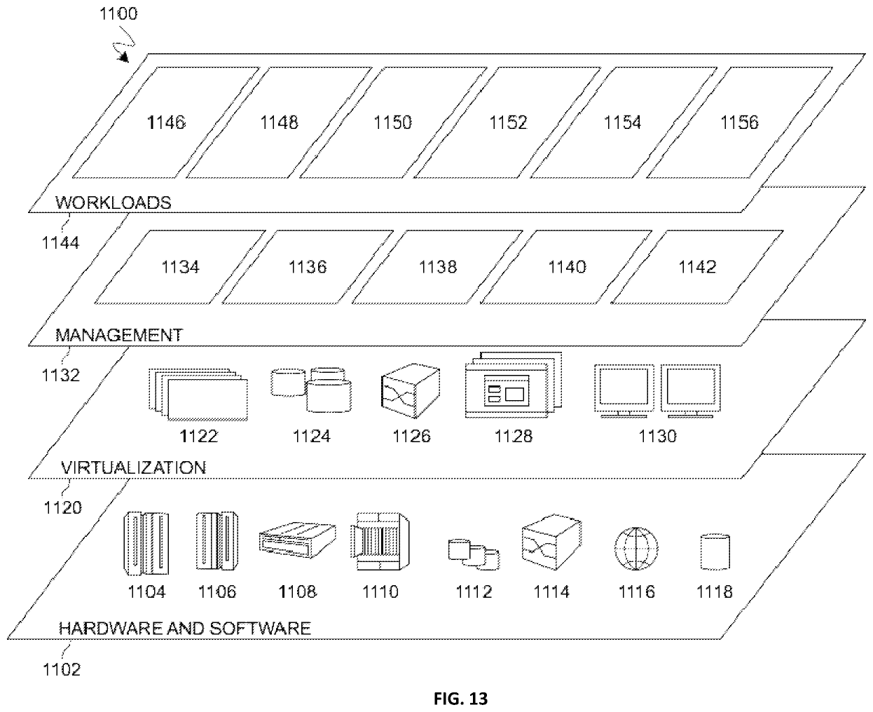

Referring now to FIG. 13, a set of functional abstraction layers 1100 provided by cloud computing environment 1000 is shown. It should be understood in advance that the components, layers, and functions shown in FIG. 13 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and visual pattern recognition 1156. A visual pattern recognition program 110a, 110b provides a way to improve the inspection of objects under specified lighting conditions, by comparing an object under inspection to a reference object.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for visual pattern recognition, the method comprising:
capturing one or more images of a reference object and an object under inspection;
processing the one or more images of the reference object and the object under inspection; and
determining that the reference object and the object under inspection are not a match.

2. The method of claim 1, wherein capturing one or more images of a reference object and an object under inspection further comprises:
utilizing a control processing unit (CPU) to direct the capturing of images by an automated optical inspection machine.

3. The method of claim 2, further comprising:
documenting the captured images with identification information, wherein the identification information is selected from the group consisting of a part number, a revision number, and a serial number.

4. The method of claim 1, wherein processing the one or more images of the reference object further comprises:
creating a visual pattern by combining the one or more images of the reference object into a single image file containing one or more layers, wherein the one or more layers depict shadows cast by the reference object.

5. The method of claim 1, wherein determining that the reference object and the object under inspection are not the match further comprises:
comparing a visual pattern of the reference object to a visual pattern of the object under inspection.

6. The method of claim 1, further comprising:
highlighting a mismatch of the reference object as compared to the object under inspection.

7. The method of claim 6, wherein the mismatch is selected from the group consisting of a missing component of the object under inspection, a damaged component of the object under inspection, and a variation of the object under inspection.

8. A computer system for visual pattern recognition, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
capturing one or more images of a reference object and an object under inspection;
processing the one or more images of the reference object and the object under inspection; and
determining that the reference object and the object under inspection are not a match.

9. The computer system of claim 8, wherein capturing one or more images of a reference object and an object under inspection further comprises:
utilizing a control processing unit (CPU) to direct the capturing of images by an automated optical inspection machine.

10. The computer system of claim 9, further comprising:
documenting the captured images with identification information, wherein the identification information is selected from the group consisting of a part number, a revision number, and a serial number.

11. The computer system of claim 8, wherein processing the one or more images of the reference object further comprises:
creating a visual pattern by combining the one or more images of the reference object into a single image file containing one or more layers, wherein the one or more layers depict shadows cast by the reference object.

12. The computer system of claim 8, wherein determining that the reference object and the object under inspection are not the match further comprises:
comparing a visual pattern of the reference object to a visual pattern of the object under inspection.

13. The computer system of claim 8, further comprising:
highlighting a mismatch of the reference object as compared to the object under inspection.

14. The computer system of claim 13, wherein the mismatch is selected from the group consisting of a missing component of the object under inspection, a damaged component of the object under inspection, and a variation of the object under inspection.

15. A computer program product for visual pattern recognition, comprising:
one or more computer-readable storage media and program instructions stored on at least one of the one or more tangible storage media, the program instructions executable by a processor to cause the processor to perform a method comprising:
capturing one or more images of a reference object and an object under inspection;
processing the one or more images of the reference object and the object under inspection; and
determining that the reference object and the object under inspection are not a match.

16. The computer program product of claim 15, wherein capturing one or more images of a reference object and an object under inspection further comprises:
utilizing a control processing unit (CPU) to direct the capturing of images by an automated optical inspection machine.

17. The computer program product of claim 16, further comprising:
documenting the captured images with identification information, wherein the identification information is selected from the group consisting of a part number, a revision number, and a serial number.

18. The computer program product of claim 15, wherein processing the one or more images of the reference object further comprises:
creating a visual pattern by combining the one or more images of the reference object into a single image file containing one or more layers, wherein the one or more layers depict shadows cast by the reference object.

19. The computer program product of claim 15, wherein determining that the reference object and the object under inspection are not the match further comprises:
comparing a visual pattern of the reference object to a visual pattern of the object under inspection.

20. The computer program product of claim 15, further comprising:
highlighting a mismatch of the reference object as compared to the object under inspection, wherein the mismatch is selected from the group consisting of a missing component of the object under inspection, a damaged component of the object under inspection, and a variation of the object under inspection.
